(19) United States
(12) Patent Application Publication
(10) Pub. No.: US 2022/0298033 A1
(43) Pub. Date: Sep. 22, 2022

(54) Method and System for Treating Wastewater

(71) Applicant: Four-E Holding GMBH, Hannoversch Muenden (DE)

(72) Inventor: Harald Klein, München (DE)

(21) Appl. No.: 17/640,031

(22) PCT Filed: Aug. 25, 2020
(86) PCT No.: PCT/DE2020/100750

§ 371 Date: Apr. 7, 2022

(30) Foreign Application Priority Data
Sep. 6, 2019 (DE) 10 2019 123 943.5

(51) Int. Cl. C02F 1/48; C02F 1/461

(52) U.S. Cl. CPC C02F 1/484; C02F 1/46104; C02F 2101/306

(57) ABSTRACT

In an embodiment a method for treatment wastewater includes exposing the wastewater to an alternating electromagnetic field in order to remove a content substance from the wastewater and selecting a resonance frequency or a frequency in proximity to the resonance frequency for splitting up and for flocculating the content substance or pails of the content substance.

This patent application is a national phase filing under section 371 of PCT/DE2020/100750, filed Aug. 25, 2020, which claims the priority of German patent application 102019123943.5, filed Sep. 6, 2019, each of which is incorporated herein by reference in its entirety.

### TECHNICAL FIELD

The present invention relates to a wastewater treatment device and a method for treating wastewater.

### BACKGROUND

It is known in the prior art to treat wastewater in such a way that the wastewater is suitable for reuse, in particular for people to drink.

### SUMMARY

One method for treating wastewater is electrolysis. Here, a direct current is applied to metal plates and the wastewater is exposed to an electric voltage field. Electrically charged particles can thus be extracted from the wastewater by being deposited on the metal plates. However, electrically neutral content substances, such as phosphates, cannot be extracted from the wastewater in this way.

Embodiments provide a method for treating wastewater in such a way, that by means of an electrolysis electrically neutral content substances can also be extracted from the wastewater.

As a first embodiment of the invention, a method for treatment of wastewater is provided, wherein the wastewater is exposed to a voltage field, in particular an alternating electromagnetic field, in order to remove a content substance from the wastewater, comprising the steps: applying the alternating electromagnetic field and applying the resonance frequency or a frequency in proximity to the resonance frequency for splitting up and flocculation of the content substance or parts of the content substance.

By means of the voltage field, electrical energy can be conducted to the content substances of the wastewater, whereby they are excited. In particular, the excitation can take place with the resonance frequency of the content substances, which on the one hand results in an internal charge separation within the individual content substance atom or molecule and, with further energy supply, a splitting up of the ingredient atom or molecule results. The parts of the content substance split up in this way can be separated by a voltage field, because they have different charges.

As a second embodiment of the invention, a wastewater treatment device is provided, comprising a secondary reactor having an elongated section along which the wastewater flows, wherein along said section metal plates are arranged in packages in such a way, that the wastewater flows along said metal plates.

As a third embodiment of the invention a computer program product is provided, comprising a software program for realizing a device for treatment of wastewater, wherein the computer program product comprises a set of instructions which cause a method according to any one of claims 1 to 3 to be carried out.

As a fourth embodiment of the invention, a computer program is provided, distributable by electronic data transmission, having computer program code means adapted to cause, when loading the program onto a computer, said computer to be able to carry out the procedure according to any one of claims 1 to 3.

Exemplary embodiments are described in the dependent claims.

According to a further exemplary embodiment of the invention, a method is provided, wherein the method comprises the further step: varying the frequency of the alternating electromagnetic field until the resonance frequency of the content substance or a frequency in proximity to the resonance frequency is reached.

By applying the resonance frequency, even with a small energy input a splitting up of the content substances can be achieved. The further away one is from the resonance frequency, the more energy has to be supplied for the content substance to break apart.

In yet another embodiment according to the invention, a method is provided, wherein the method is suited for removing phosphates, triazine herbicides, acidic pesticides, perfluorooctanoic acid, perfluorooctanesulfonic acid, benzotriazole, 4-methyl-1H-benzotriazole, 5-methyl-1H-benzotriazole, ethylenediaminetetraacetic acid, diethylenediaminepentaacetic acid, carbamazepine, diclifenac, 17β-estradiol, estrone, gabepentine, iohexol, iomeprol, iopamidol, iopromide, irbesartan, metoprolol, sulfamethoxazole from the wastewater.

According to an exemplary embodiment of the invention, a wastewater treatment device is provided, comprising a secondary reactor having an elongated section along which the wastewater flows, wherein along said section metal plates are arranged in packages in such a way that wastewater flows along said metal plates.

In a further embodiment according to the invention, a wastewater treatment device is provided, wherein 2, 3 or any number of metal plate packs are arranged, wherein metal plate packs in proximity to the inlet are arranged with an alternating charge and wherein in the case of the metal plate packs in proximity to the outlet the metal plates with a first charge are arranged more on a first side and the metal plates with a second charge are arranged more on the second side.

In a first area, the priority is to supply energy. In this case, short distances between differently charged plates are advantageous. In this way, high voltage fields can be established more easily. In a rear part the differently charged split up parts of the content substances are already present. In this area it is important to separate the differently charged parts of the content substances. It then makes sense to bundle similarly charged plates in one place, whereby oppositely charged parts of the content substances can be deflected to this place.

According to a further embodiment of the invention, a wastewater treatment device is provided, wherein a separating device having a separating wall is arranged in proximity of the outlet.

With a separating device, the differently charged parts of the content substances can be separated mechanically.

In a further embodiment according to the invention, a wastewater treatment device is provided, wherein said wastewater treatment device is provided for carrying out a method.

Embodiments provide exposure of wastewater to an alternating electromagnetic field, wherein the frequency of the alternating field is intended to correspond to the resonance frequency of a content substance to be removed from the wastewater. By excitation of the content substance to natural oscillations, the molecules of the content substances break apart as a result of overshooting. As a result, the previously electrically neutral molecule breaks apart into electrically charged parts. These parts can be extracted from the wastewater by an electric field, which allows the wastewater to be cleaned.

Embodiments are based on the finding that every atom and every molecule has a natural oscillation. If the atom or molecule is excited, that is, if energy is supplied to the atom or molecule, it can absorb this energy and release it again.

However, if a lot of energy is supplied to the atom or molecule, or if energy is supplied to the atom or molecule at its resonance frequency, the atom or molecule can become “overloaded”. In particular, when energy is supplied at the resonance frequency, a “resonance disaster” can occur, in which the atom or molecule breaks apart and is present in its individual parts.

An atom or a molecule has no external charge. After the atom or molecule has broken apart, there may be individual parts of the atom or molecule that are positively or negatively charged. These charged parts can be separated by a voltage field and/or filtered out of a wastewater.

The individual features may, of course, also be combined with one another, which in some cases may also result in advantageous effects surpassing the sum of the individual effects.

### BRIEF DESCRIPTION OF THE DRAWINGS

Further details and advantages of the invention become apparent from the exemplary embodiments illustrated in the drawings.

FIG. 1 shows a primary reactor 1;

FIG. 2 shows a secondary reactor 2 in a side view;

FIG. 3 shows a secondary reactor 2 in a top view;

FIG. 4 shows a cover for the secondary reactor 2;

FIG. 5 shows the secondary reactor 2 in a side view;

FIG. 6 shows a cover for the secondary reactor 2;

FIG. 7 shows the secondary reactor 2 in a top view;

FIG. 8 shows a top view of the system with primary reactor 1 and secondary reactor 2; and

FIG. 9 shows a side view of the system with primary reactor 1 and secondary reactor 2.

### DETAILED DESCRIPTION OF ILLUSTRATIVE EMBODIMENTS

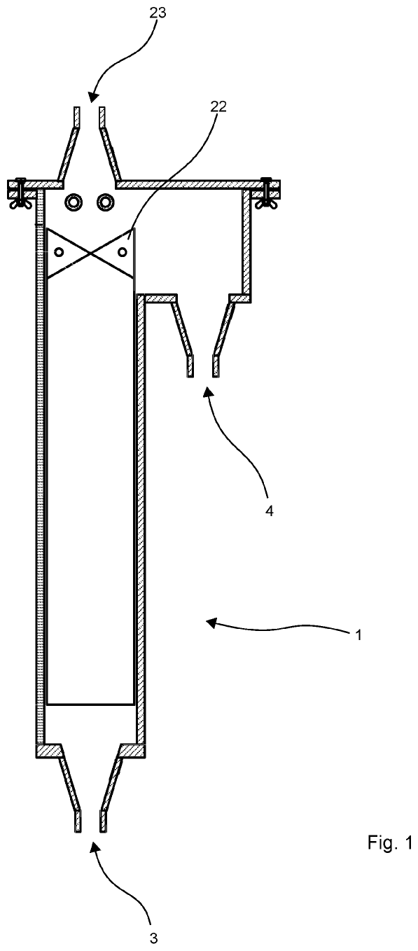

FIG. 1 shows a primary reactor 1 for a first cleaning of the wastewater, for example from solid content substances, such as suspended solids. An initial treatment can be carried out by the electrodes 22, as a result of which the solid contents can be agglomerated and thereby removed. The wastewater to be cleaned is introduced into the primary reactor through the inlet 3 and discharged from the primary reactor through the outlet 4. The primary reactor 1 has an outlet 23 for ventilation, whereby harmful or explosive gases can escape from the system.

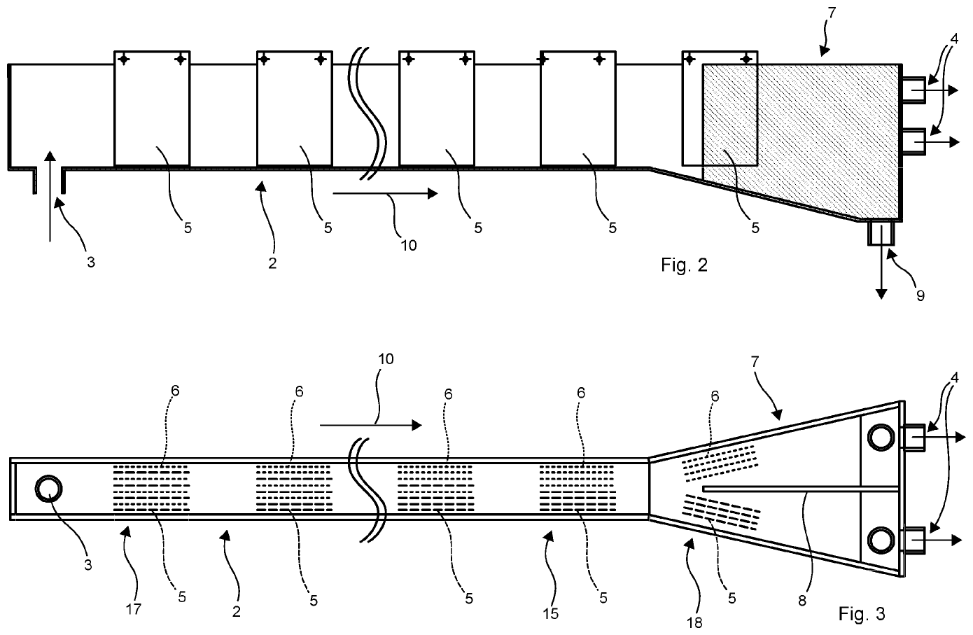

FIG. 2 shows a secondary reactor 2 in a side view. The secondary reactor 2 has in its direction of flow, direction in which the wastewater flows, starting from the inlet towards the outlet a cascading of metal plates 5 and 6, to which an alternating electromagnetic field is connected. A separating device 7 is arranged shortly before the outlet, which separates the differently charged water, i.e., the split up molecules.

FIG. 3 shows the secondary reactor viewed from above with the metal plates 5 and 6. The metal plates 5 are cathodes in one half-wave of the voltage supply, i.e., negatively charged, and the metal plates 6 are anodes, i.e., positively charged. In the following half-wave, the charge changes. Near the inlet 3 several metal plates 5 and 6 can be arranged one behind the other perpendicular or transverse to the direction of flow. The charges can be formed in an alternating manner perpendicular to the direction of flow, so that an anode metal plate alternates with a cathode metal plate. Further metal plate packs 15, 17 and 18 can be arranged along the direction of flow, whereby the arrangement can increasingly be such that on one side more anode metal plates 6 and on the other side more cathode metal plates 5 are arranged. In a last package 15, on one side only anode metal plates 6 can be arranged and on the other side only cathode metal plates 5 can be arranged. The wastewater and/or its content substances are then separated in such a way that on one side the positively charged content substances and on the other side the negatively charged content substances are gathered. In the further direction of flow 10 a separating device 7 having a separating wall 8 can be arranged in such a way, that the differently charged parts are separated and can be collected in different outlets 4.

FIG. 3 shows in particular a pack of charge carrier plates 17, wherein the respective individual plates 5 and 6 can have a different charge. Said charge plate pack 17 is arranged in a first section of the device close to the inlet, wherein the individual charge plates 5 and 6 are arranged alternately in the direction up or down, respectively, with respect to the plane of the drawing. In this front section of the device, it is exclusively about adding energy to the wastewater, wherein the energy should have a frequency that corresponds to the resonance frequency of the molecule or atom to be split up or should at least be in its proximity. A separation of already split up content substances is not possible in this section, since a splitting up has not yet occurred. In addition, the alternating arrangement is also advantageous because a merely short distance can be realized between differently charged plates 5 and 6 as a result. This makes it easier to build up a strong voltage field. At the end of the device another charge carrier package 15 with individual plates 5 and 6 is arranged. In this charge carrier package 15, the plates 5 and 6 are arranged in sorted manner according to their charge. In the drawing, the plates 6 are arranged at the top and the plates 5 at the bottom. In this section at the end of the device, the content substances have already been split up during their run through the device, which is why only a separation and filtering of the split up content substances is carried out in this section.

The charge packs 18 guide the differently charged split up parts of the content substances into different containers.

A flocculation of ingredients is therefore prevented by electromagnetic fields or waves, with an excitation of the molecules of the ingredients being intended. For this purpose, the metal plates in the secondary reactor 2 are provided, which supply energy to the content substances to be precipitated in resonant compatibility. This results in an inharmonic overshoot, which causes charge separation within the atom and/or molecule of the content substance and ultimately the breaking apart of the atom or molecule into its differently charged parts.

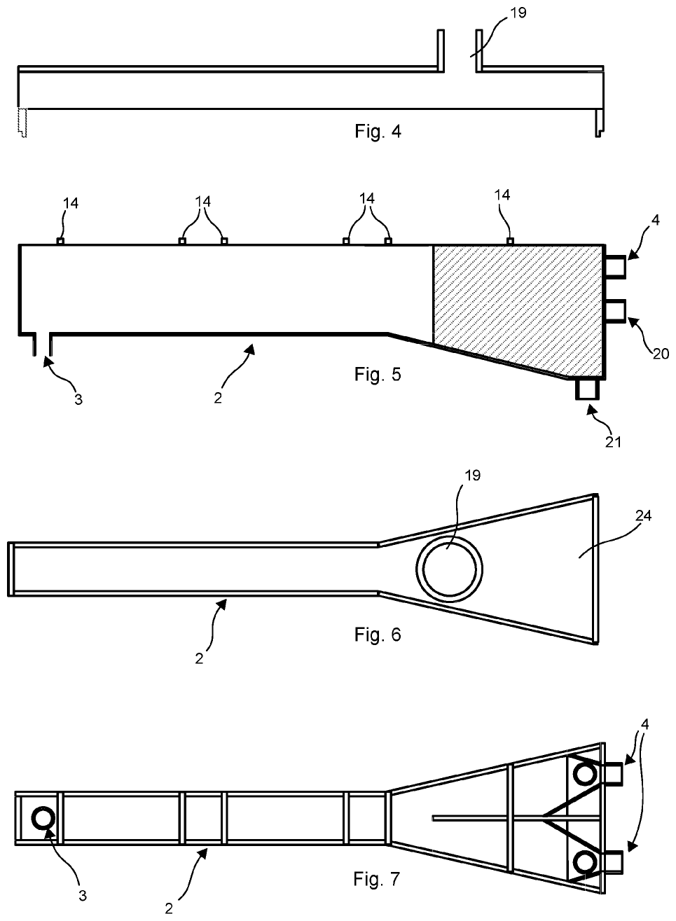

FIG. 4 shows a cover of a secondary reactor having a suction opening 19 for existing or emerging gas components.

FIG. 5 shows the secondary reactor 2 in a side view with the inlet 3 and the outlets 4, 20 and 21.

The outlet 4 serves for the discharge of floating layers. The outlet 20 is provided for the discharge of the clear phase and the outlet 21 is provided for the discharge of the bottom sludge. The webs 14 serve for fastening, for support or for arrangement of the electrodes 5.

FIG. 6 shows the secondary reactor 2 with the suction opening 19, so that gases produced, for example noxious, combustible or explosive gases, can escape from the secondary reactor 2 and/or be suctioned off. The secondary reactor 2 is shown in a top view, with the cover 24 resting on the secondary reactor 2.

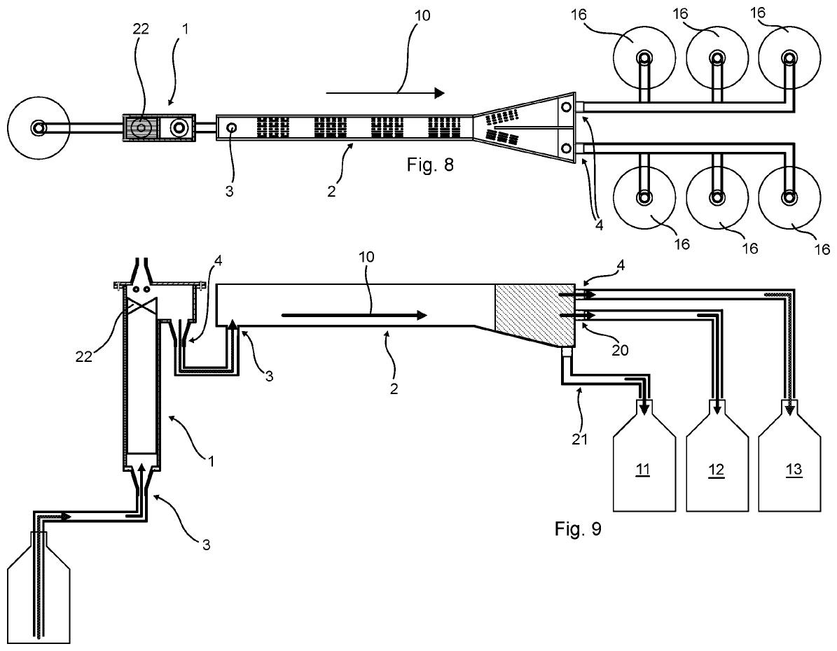

FIG. 7 shows in a top view the secondary reactor 2 with the inlet 3 and the outlets or drains 4, 20 and 21. The secondary reactor 2 is shown in a top view without the cover 24.

FIG. 8 shows the complete system with the primary reactor 1 and the secondary reactor 2 in a top view.

Collecting containers 16 are also shown.

FIG. 9 shows the complete system with the primary reactor 1 and the secondary reactor 2 in a side view.

In addition, collecting containers 11, 12 and 13 are shown.

It shall be noted that the term “comprising” does not exclude other elements or steps, just as the terms “a” and “an” do not exclude multiple elements and steps.

The reference numbers used are for increased comprehensibility only and should not be taken as limiting in any way, the scope of the invention being indicated by the claims.

### LIST OF REFERENCE NUMBERS

1 primary reactor
2 secondary reactor
3 inlet
4 outlet for floating layers
5 metal plate
6 metal plate
7 separating device
8 separating wall
9 sludge outlet
10 direction of flow
11 collecting container for bottom sludge
12 collecting container for the clear phase
13 collecting container for the floating layer
14 webs on which electrodes 5 are fastened or arranged
15 with respect to the inlet rearward charge plates
16 collecting container
17 with respect to the inlet forward charge plates
18 charge plates only for filtering the split up content substance
19 suction opening, so the gas that is produced can be sucked out
20 outlet for the clear phase
21 outlet for the bottom sludge
22 electrodes
23 outlet for gases
24 cover of the secondary reactor 2

1.-9. (canceled)

10. A method for treatment of wastewater, the method comprising:
exposing to an alternating electromagnetic field in order to remove a content substance from the wastewater; and
selecting a resonance frequency or a frequency in proximity to the resonance frequency for splitting up and for flocculating the content substance or parts of the content substance.

11. The method according to claim 10, further comprising:
varying the frequency of the alternating electromagnetic field until reaching the resonance frequency of the content substance or the frequency in proximity to the resonance frequency.

12. The method according to claim 10, further comprising:
removing phosphates, triazine herbicides, acidic pesticides, perfluorooctanoic acid, perfluorooctanesulfonic acid, benzotriazole, 4-methyl-1H-benzotriazole, 5-methyl-1H-benzotriazole, ethylenediaminetetraacetic acid, diethylenediaminepentaacetic acid, carbamazepine, diclifenac, 17β-estradiol, estrone, gabepentin, iohexol, iomeprol, iopamidol, iopromide, irbesartan, metoprolol or sulfamethoxazole from the wastewater.

13. The method according to claim 10, further comprising:
removing phosphates, triazine herbicides, acidic pesticides, perfluorooctanoic acid, perfluorooctanesulfonic acid, benzotriazole, 4-methyl-1H-benzotriazole, 5-methyl-1H-benzotriazole, ethylenediaminetetraacetic acid, diethylenediaminepentaacetic acid, carbamazepine, diclifenac, 17β-estradiol, estrone, gabepentin, iohexol, iomeprol, iopamidol, iopromide, irbesartan, metoprolol and sulfamethoxazole from the wastewater.

14. A non-transitory computer storage medium storing a program to be executed by a processor, wherein the program includes instruction to perform the method of claim 10.

15. A wastewater treatment device comprising:
a secondary reactor having an elongated section; and
metal plates arranged as metal plate packages along the elongated section so that wastewater is flowable along the metal plates.

16. The wastewater treatment device according to claim 15, wherein the metal plate packages comprises two more metal plate packages, wherein first metal plate packages are arranged in proximity to an inlet such that metal plates of the first metal plate packages are configured to provide first and second charges alternatingly, and wherein second metal plate packages arranged in proximity to an outlet such that metal plates of the second metal plate packages configured to provide a first charge are arranged on a first side of the outlet and metal plates of the second metal plate packages are configured to provide a second charge are arranged on a second side of the outlet.

17. The wastewater treatment device according to claim 15, further comprising a separating device comprising a separating wall, wherein the separating device is arranged in proximity of an outlet of the secondary reactor.
